(19) United States
(12) Patent Application Publication
(10) Pub. No.: US 2022/0186392 A1
(43) Pub. Date: Jun. 16, 2022

(54) ENGINEERING PROCESS FOR HALOGEN SALTS, USING TWO IDENTICAL ELECTRODES

(71) Applicant: Deutsches Zentrum für Luft- und Raumfahrt e.V., Köln (DE)

(72) Inventors: Wenjin DING, Stuttgart (DE); Thomas BAUER, Köln (DE); Fan YANG, Stuttgart (DE)

(73) Assignee: Deutsches Zentrum für Luft- und Raumfahrt e.V., Köln (DE)

(21) Appl. No.: 17/593,515

(22) PCT Filed: Mar. 18, 2020
(86) PCT No.: PCT/EP2020/057414

§ 371 Date: Sep. 20, 2021

(30) Foreign Application Priority Data
Mar. 22, 2019 (DE) 10 2019 107 393.6

(51) Int. Cl. C25C 3/04; C25C 7/02; C25C 7/00

(52) U.S. Cl. CPC C25C 3/04; C25C 7/005; C25C 7/02

(57) ABSTRACT

The invention relates to a process and devices for reducing impurities in molten salts, a molten salt being purified in an electrochemical process by applying a voltage between two electrodes. According to the invention, the voltage is varied so that in different phases different electrodes act as cathode or anode.

The present invention relates to processes and devices for reducing contaminants in salt melts that are employed as thermal energy storage systems in solar thermal power plants, in which a molten salt is purified in an electrochemical process by applying a voltage between two electrodes. According to the present invention, the voltage is varied so that different electrodes act as the cathode or anode in different phases.

For some years, salt melts have been used in solar thermal power plants as thermal energy storage systems, allowing for an efficient large-scale transfer and storage of thermal energy. For example, so-called solar salt is employed in solar thermal power plants as a heat transfer and storage medium in the prior art, which is a mixture of two nitrate salts consisting of 40% by weight potassium nitrate and 60% by weight sodium nitrate. The operating temperature of such salt melts is limited by the melting temperature of the salt and its decomposition temperature. The maximum operating temperature of such nitrate salts is about 560° C. At higher temperatures, decomposition occurs. Alternative salt melts that may be employed at higher temperatures could improve the efficiency of downstream processes in solar power plants (for example, in steam turbines for power generation), and additionally find use also in other industrial processes as a high temperature heat transfer medium.

As an alternative for nitrate-based solar salt, salt melts having a higher decomposition temperature may be considered, for example, halogen salt melts, especially chloride salt melts, the latter having decomposition temperatures of more than 800° C. For example, mixtures of MgCl₂/KCl/NaCl show good properties. However, there is a problem in that such salt melts, because of contaminants, are often highly corrosive towards metals. Upon contact with air or moisture, the salts form hydrates, whose decomposition during the heating and melting process results in the formation of corrosive oxygen- and/or hydrogen-based contaminants, especially hydroxy compounds, dissolved hydrogen ions (H⁺), dissolved oxygen, or dissolved water in the salt melt. Further, air may come into contact with the salt melt also during use, wherein corrosive oxygen- and/or hydrogen-based compounds may be formed. Therefore, in order to be able to employ high temperature salt melts as a thermal transfer and storage medium, processes are necessary that can reduce the corrosiveness of the salt melts by purifying the salt melts or removing oxygen- and/or hydrogen-based contaminants.

A process for purifying high temperature salt melts that contain oxygen- and/or hydrogen-based contaminants is disclosed in the as yet unpublished U.S. patent application Ser. No. 16/003,229, which is included herein by reference in its entirety. It describes the purification of a salt melt by electrolysis. The salt melt is brought into contact with two electrodes, and a voltage is applied between them. One of the electrodes acts as the cathode on which hydroxide-based contaminants are converted to oxides and hydrogen by reduction, wherein the oxides precipitate from the salt melt because of their higher melting points. The other electrode acts as the anode, wherein the electrode material is dissolved by oxidation and becomes part of the salt melt. Materials that are electrochemically inert at the voltages applied, such as tungsten, silver, gold, platinum, palladium or nickel alloys, are employed as the cathode material. Alkali metals, alkaline earth metals, transition metals or metalloids having a low reduction potential are employed as the anode material.

This prior art process has the disadvantage that electrolysis products deposit at the cathode in the course of the process, which increasingly leads to passivation of the electrode, so that the electric current clearly decreases already after relatively short periods of time, and thus the efficiency of the purification is reduced. Therefore, the voltage applied must be switched off on a regular basis, and the cathode cleaned or replaced.

Therefore, it is the object of the present invention to provide a process for the electrolytic purification of salt melts that avoids the drawbacks of the prior art.

In a first embodiment, this object is achieved by a process for purifying salt melts, comprising the following steps:
i) providing a salt melt, wherein said salt melt contains at least one oxygen-based and/or at least one hydrogen-based contaminant;
ii) contacting the salt melt electrically and physically with at least one first electrode and at least one second electrode, wherein said electrodes are not in mutual contact within the salt melt;
iii) variably applying a voltage between said at least one first electrode and said at least one second electrode, so that an electric current flows between the electrodes, wherein said oxygen- and/or hydrogen-based contaminant is at least partially removed by an electrochemical reaction on at least one of the electrodes;

characterized in that the voltage is varied in such a way that said at least one first electrode acts as the cathode and said at least one second electrode acts as the anode during at least one first phase, and said at least one first electrode acts as the anode and said at least one second electrode acts as the cathode during at least one second phase.

This process differs from the prior art, in particular, by the fact that the voltage applied is varied, so that different electrodes act as the cathode or anode at different times. Surprisingly, it has been found that the passivation of the cathode can be reduced or decelerated thereby. In particular, an electrode acting as the anode is gradually dissolved by oxidation of the anode material, in which the formed cations are transferred into the salt melt. During this process, in particular, electrolysis products that were deposited at the electrode while the electrode acted as the cathode before can be released.

Step ii) is to be understood in such terms that the electrodes are not in contact with one another in a spatial sense, i.e., do not touch.

In a preferred embodiment, the voltage applied is varied in such a way that said at least one first electrode and said at least one second electrode alternately act as the anode, the other electrode respectively acting as the cathode. Preferably, a first voltage and a second voltage are alternately applied, wherein said second voltage is the same as said first voltage, but with the sign reversed. However, the voltages may also have reversed signs and different absolute values. The voltage change can be carried out continuously or discontinuously. For the function of the two electrodes as the cathode or anode to swap, the sign of the voltage must be reversed, so that the direction of an electric current flowing between the electrodes is also reversed.

In a preferred embodiment, the voltage is varied with a period length within a range of from 0.1 to 10 seconds, especially within a range of from 1 to 5 seconds, i.e., 1, 2, 3, 4, 5, 6, 7, 8, 9, or 10, especially 1, 2, 3, 4, or 5 seconds. This means that, for example, a positive voltage is applied for a duration of 4 seconds. After 4 seconds, a voltage with a negative sign is applied, again for a duration of 4 seconds. This swap is repeated periodically. However, the voltage may also be varied with a shorter or longer period length. However, too long a period length is to be avoided. If too long a period length of, for example, more than 10 seconds is chosen, the passivation of an electrode acting as the cathode will advance to the point where the electrode can no longer act efficiently as an anode afterwards, or the passivation is no longer completely reversible. Therefore, shorter period lengths are preferred. When the change is too quick, there is a risk of overload.

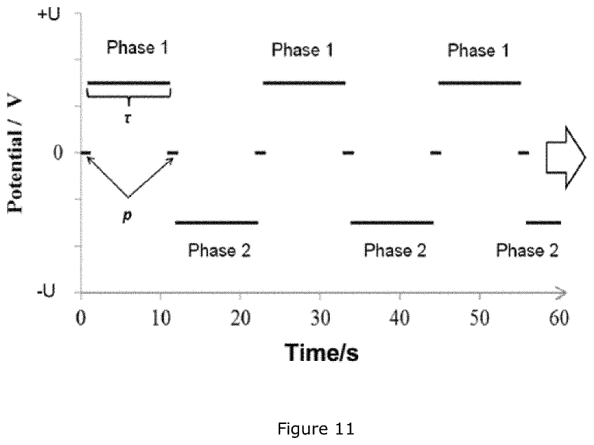

Also, a break during which no voltage is applied can be provided between the voltage swaps in order to avoid an overload during the swap. Such a break is dependent on the voltage applied, and on the period length. Suitable break durations are from 0.1 to 3 seconds, especially from 0.5 to 2 seconds, preferably 1 second. An exemplary voltage swap is shown in FIG. 11. It illustrates the two phases of changing voltage, wherein the phase duration is designated with τ. Breaks are designated with p.

During the electrolysis, the measured electric current between the electrodes decreases, which can be attributed, on the one hand, to a decreasing concentration of impurities and, on the other hand, to an increasing passivation of the electrode acting as the cathode. Therefore, in an alternative embodiment, the voltage may also be varied as a function of a measured current between the electrodes, according to which the sign of the voltage applied between the electrodes is swapped after the current has decreased below a particular threshold.

The voltage applied and the frequency with which the voltage is varied may also be changed in the course of the process. In particular, a voltage that is significantly higher than that required for the electrolysis can be applied for some time, in order to additionally remove electrolysis products adhering to an electrode. Firstly, the formation of gases at an electrode can be induced, which may lead to the chipping off of deposits on the electrode. Further, a high voltage may heat the electrode, which may also lead to the removal of deposits, especially from different thermal expansions of the deposits and the electrode, the partial melting of the deposit, or the partial dissolution of the deposit in the salt melt.

The process according to the invention may include further measures to counteract the passivation of an electrode. Thus, deposits on an electrode may also be removed mechanically, especially by scraping or grinding. Ultrasound may also be used to remove deposits. Heating elements may be incorporated into an electrode so that the electrode can be heated up, in which deposits can chip off. Another possibility is the rinsing with inert gas or stirring of the salt melt, in which pressure is also applied to deposits mechanically. In particular, the salt melt may also flow past the electrode and thereby reduce the formation of deposits on the electrode.

In a preferred embodiment, a halogen salt melt is employed as the salt melt. Within the scope of the present invention, “halogen salt” means any salt that contains at least one ion of fluorine, chlorine, bromine, and/or iodine. Preferably, a chloride salt is employed. Chloride salts are generally less expensive than other halogen salts, so that the process according to the invention can be performed cost-effectively. In addition, suitable chloride salts can be handled simply even in large amounts, because they are not toxic and do not have any other negative effects on the safety and health of humans, either. In principle, however, any other halogen salt may also be employed.

The salt melt employed contains cations for charge compensation. In particular, those cations that form a high-temperature resistant salt with the halogen anions are employed in a halogen salt. Within the scope of the present invention, a salt is considered to be high-temperature resistant if its decomposition temperature is above 700° C., especially above 1000° C., so that it can be employed as a high-temperature heat storing system and transfer medium. Further, liquid salts that have a low vapor pressure at the maximum operating temperature are preferred.

Preferably, cations of the elements Mg, Ca, Na, K, Li, Sr, Ba, Zn, Al, Sn, Fe, Cr, Mn, Ni and/or mixtures thereof are employed in a halogen salt. More preferably, cations of the elements Mg, Ca, Ba, Na and/or K are employed in a halogen salt. In particular, the salt melt may contain MgCl₂, CaCl₂), NaCl, BaCl₂ and/or KCl or consist of one of the mentioned compounds or a mixture thereof.

In particular, a mixture of two or more salts may also be employed as a salt melt. The mixture of the salt melt may have lower melting temperatures as compared to individual salts, and the temperature range can be extended thereby, or the minimum temperature lowered. In this way, the melting temperature, the heat capacity and the vapor pressure can be adjusted by a selective combination of salts having the corresponding properties.

Before being employed in the process according to the invention, the salt melt may be exposed to a vacuum first. In particular, the salt melt or salt may be exposed to a vacuum at a temperature within a range of from 20° C. to 300° C. Preferably, the temperature is within a range of from 80 to 250° C., more preferably 100 to 200° C. The vacuum treatment can dehydrate the salt, wherein the content of contaminants can be reduced by a decreased hydrolysis during the heating.

The process according to the invention is preferably performed under an inert gas atmosphere. This prevents the salt melt from coming into contact with water and/or oxygen during the electrolytic purification, which could form new contaminants. Therefore, within the meaning of the present invention, an “inert gas atmosphere” means an atmosphere that is substantially free of water and/or oxygen, or preferably free of water and oxygen. Examples of suitable inert gases include nitrogen or argon.

In the process according to the invention, at least two electrodes are employed that respectively act as the cathode or anode at different times. However, more than two electrodes may also be employed, wherein each electrode can act as the anode or cathode at times because of the variable application of voltages between the electrodes. For this purpose, more than two electrodes may be subdivided into groups that alternately act as a cathode or anode, or the individual electrodes may also be employed individually as the anode at times, and as the cathode at times, by the variable applying of voltages between the electrodes. Preferably, 3, 4, 5, 6, 7, 8, 9, 10 or more electrodes are employed. The number of electrodes depends on the space requirements, and on the amount of salt melt and contaminants.

According to the invention, each electrode that was employed as the cathode at times is employed as the anode in another phase, wherein the passivation of the electrode is avoided or reduced, in particular, by dissolving the anode material.

At an electrode acting as the cathode, electrons are provided, wherein an oxygen- and/or hydrogen-based contaminant, in particular, is removed from the salt melt by reduction. The required electrons are provided by an oxidation reaction at an electrode acting as the anode, wherein the anode material itself, in particular, is oxidized, and the cations formed are transferred into the salt melt.

According to the invention, said at least two electrodes are both employed as the anode at times, and therefore must comprise a material that is suitable as an anode in the process according to the invention. For the anode to provide electrons by oxidation, each of the electrodes must comprise a material that has a suitable reduction potential, so that an oxygen- and/or hydrogen-based contaminant can be reduced at the cathode, and the anode can be oxidized at the same time by applying a suitable voltage. In a preferred embodiment, said at least one first electrode and/or said at least one second electrode comprise a material with a reduction potential that is not higher than the reduction potential of an oxygen- and/or hydrogen-based contaminant. Further, the reduction potential is preferably not higher than the reduction potential of an element employed as an anion in the salt melt, because otherwise an undesirable oxidation of the salt melt could occur at the anode. In addition, the reduction potential is preferably not lower than the reduction potential of an element employed as a cation in the salt melt, because otherwise an undesirable reaction of the electrode with the salt melt could take place.

Preferably, said at least one first electrode and/or said at least one second electrode comprise a material with a normal potential (reduction potential) within a range of from −0.1 to −3.1 V, preferably within a range of from −0.4 to −2.95 V. More preferably, one or both electrodes are made of such a material. The normal potential designates the electrical potential difference between the electrode and a standard hydrogen electrode (2H⁺+2 e⁻->H₂) under standard conditions.

Preferably, said at least one first electrode and/or said at least one second electrode comprise a material that has a reduction potential within a range of from −0.6 to −1.6 V, preferably within a range of from −0.8 to −1.5 V, at a temperature of 500° C. in a salt melt with respect to a tungsten electrode immersed into the salt melt (W²⁺+2 e⁻->W). In particular, one or both electrodes can consist of such a material.

Said at least one first electrode and/or said at least one second electrode may comprise different materials, or be made of the same material. Preferably, the same material is employed for both electrodes. In such a case, both electrodes are similarly suitable as an anode and as a cathode.

In a preferred embodiment, said at least one first electrode and/or said at least one second electrode comprise an alkali metal, an alkaline earth metal, a transition metal, and/or a metalloid. Suitable alkali metals include, in particular, lithium, sodium, potassium, or mixtures thereof. Suitable alkaline earth metals include, in particular, magnesium, calcium, strontium, barium, or mixtures thereof. Suitable transition metals include, in particular, cobalt, nickel, iron, zinc, or mixtures thereof. Suitable metalloids include, in particular, boron, silicon, or mixtures thereof. The reactive alkali metals and alkaline earth metals described may also be within a matrix structure of an inert material (for example, steel), in order to improve mechanical stability, or minimize the passivation.

Without the present invention being bound by the following theory, it is considered that the following reactions take place at the anode and cathode, wherein, in particular, A designates an alkaline earth metal, and B designates a halogen in the following. If a different metal or metalloid is employed as the element A, the following equations will apply with correspondingly adapted charges and stoichiometric coefficients.

| | | |
|---|---|---|
| Electrolyte reaction 1: | 2 AOHB | →2 AOH⁺ + 2B⁻ |
| Cathode (reduction): | 2 AOH⁺ + 2 e⁻ | → 2 AO + H₂ |
| Anode (oxidation): | A | → A2⁺ + 2e⁻ |
| Electrolyte reaction 2: | A²⁺ + 2B⁻ | → AB₂ |
| Overall reaction: | 2 AOHB + A | → AB₂ + 2 AO + H₂ |

Hereinbelow, the reactions are represented in an exemplary way for an MgCl₂ melt that contains MgOHCl as a typical contaminant, using magnesium as an electrode material:

| | | |
|---|---|---|
| Electrolyte reaction 1: | 2 MgOHCl | → 2 MgOH⁺ + 2 Cl⁻ |
| Cathode (reduction): | 2 MgOH⁺ + 2 e⁻ | → 2 MgO(s) + H₂(g) |
| Anode (oxidation): | Mg(s) | → Mg²⁺ + 2 e⁻ |
| Electrolyte reaction 2: | Mg²⁺ + 2 Cl⁻ | → MgCl₂ |
| Overall reaction: | 2 MgOHCl + Mg(s) | → MgCl₂ + MgO(s) + H₂(g) |

In this example, magnesium is employed as the electrode material. Magnesium is oxidized at the anode, wherein the electrode is partially dissolved. The Mg²⁺ ions formed are transferred into the salt melt. MgOHCl represents a typical oxygen-based contaminant in MgCl₂ melts. In the melt, it is in the form of MgOH⁺ and Cl⁻ ions. Upon applying a voltage, MgOH⁺ reacts at the cathode to MgO with formation of hydrogen. Because of its high melting point and its poor solubility in the salt melt, MgO is not transferred into the salt melt, but remains at the cathode, or is precipitated.

Especially if MgO remains at the cathode as a deposit, a passivation of the electrode employed as the cathode takes place in the course of the process. However, according to the present invention, this electrode is employed as the anode at a later time, wherein material of the electrode is dissolved. It is considered that precipitates deposited thereby (MgO) are released on the electrode without the present invention being limited to this theory.

In the process according to the invention, in particular, an anode material is dissolved to form cations, which remain in the salt melt. Therefore, an element whose cations are already part of the salt melt employed is preferably employed as the electrode material. For example, if MgCl₂ is employed as a salt, it is particularly preferred to employ electrodes made of magnesium.

In particular, an electrode employed is being consumed in the course of the process according to the invention. Therefore, a consumed electrode can be replaced by a new electrode on a regular basis. Another possibility is the constant supply of electrode material in the form of a wire, band or foil. Preferably, the electrode has a large surface, and may also be employed, for example, in the form of a sheet, a mesh, an open-pore foam, or a perforated plate.

More preferably, the process according to the invention comprises the following steps:
i) providing a salt melt, wherein said salt melt contains at least one oxygen-based and/or at least one hydrogen-based contaminant, especially at least one oxygen-based contaminant;
ii) contacting the salt melt electrically and physically with at least one first electrode and at least one second electrode, wherein said electrodes are not in mutual contact within the salt melt;
iii) variably applying a voltage between said at least one first electrode and said at least one second electrode, so that an electric current flows between the electrodes, wherein said oxygen- and/or hydrogen-based contaminant is at least partially removed by an electrochemical reaction on at least one of the electrodes;

characterized in that the voltage is varied in such a way that said at least one first electrode acts as the cathode and said at least one second electrode acts as the anode during at least one first phase, and said at least one first electrode acts as the anode and said at least one second electrode acts as the cathode during at least one second phase;

wherein said salt melt contains chloride salts of Mg, Na, and K.

More preferably, the salt melt contains MgCl₂, NaCl and KCl, and preferably consists of these three salts. More preferably, an Mg anode is employed as the anode. Said oxygen-based contaminant is, in particular, oxides or hydroxides of Mg, Na and/or K, especially oxides or hydroxides of Mg.

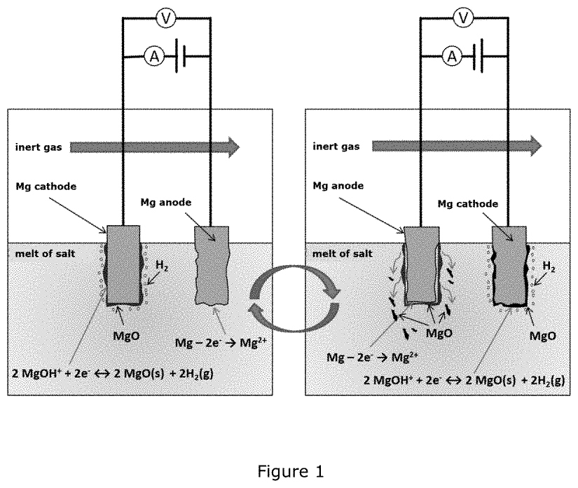

FIG. 1 illustrates the process according to the invention in an exemplary way for MgCl₂ as the salt melt, and electrodes made of magnesium. It shows how swapping between an Mg cathode and an Mg anode is performed during the electrochemical purification of a salt melt according to the invention (by reversing an applied voltage), in order to avoid passivation of the cathode by the MgO formed. On the left-hand side of FIG. 1, it is shown how the left Mg electrode is employed as the cathode during a first phase to remove MgOH⁺, while the right Mg electrode is employed as an anode, in which magnesium is consumed. MgO is produced on the surface of the cathode (left Mg electrode), which leads to passivation of the electrode. Therefore, before irreversible passivation occurs (for example, 3.5 seconds after the first phase), the function of the two electrodes is swapped in a second phase, as shown on the right-hand side of FIG. 1. In the second phase, the left Mg electrode having MgO deposits on the surface (the cathode from the first phase) is employed as an anode, while the right Mg electrode (the anode from the first phase) is employed as a cathode. The reaction of Mg to Mg²⁺ on the anode makes the MgO deposited on the surface fall off, and the electrode surface is renewed. By continuously repeating the two phases, contaminants, such as MgOH⁺, can be removed, wherein passivation of the cathode is avoided. The formation of MgO at the cathode, the falling off of the MgO and the renewal of the electrode surface can also be confirmed by microstructural analytical methods, such as scanning electron microscopy (SEM), energy-dispersive X-ray spectroscopy (EDX), and X-ray diffractometry (XRD).

The process according to the invention is preferably performed at a temperature that is clearly below the decomposition temperature of the salt melt employed. In a preferred embodiment, the process according to the invention is performed at a temperature within a range of from 300 to 800° C. In another embodiment, the process is performed at a temperature within a range of from 390 to 650° C., preferably at a temperature within a range of from 450 to 600° C., more preferably within a range of from 480 to 550° C., especially at about 500° C. The preferably employed salts NaCl, KCl, MgCl₂ and/or CaCl₂) are in a solid form below a temperature of 350° C. depending on the mixing ratio. For example, the system has an NaCl—KCl—MgCl₂ mixture with a minimum melting temperature of about 380° C.

The process is performed at a temperature that is higher than the melting temperature of the salt employed. Depending on at what temperature the process is performed and which electrode material is employed, one or more of the electrodes employed may be in a liquid or solid form. Especially if alkali metals, such as Li, Na and/or K, are employed as the electrode material, one or more electrodes may be in a liquid form. Because of the density differences between the salt melt and the electrode, a liquid electrode may float on the salt melt, for example. Alkali metals are preferably employed in combination with alkali metal salt melts, whereby it is avoided that foreign ions are transferred into the salt melt from the anode becoming dissolved, and adversely change its properties.

If high melting metals are employed as an electrode material, the electrode is preferably in a solid form. Especially alkaline earth metals are preferably employed in a solid form. If magnesium is employed as an electrode material, the process is preferably performed at a temperature of 650° C. or less. The use of a solid electrode has the advantage that the material of the electrode cannot mix with the salt melt and subsequently deposit as a precipitate in conduits, valves and pumps that convey the salt melt and are operated below the melting temperature of the electrode material.

The concentration of oxygen- and/or hydrogen-based contaminants in the salt melt can be determined before, during and after the process, for example, using cyclic voltammetry. A corresponding method is described in the unpublished U.S. patent application Ser. No. 16/003,229, which is included herein by reference in its entirety. A detailed description of cyclic voltammetric measurements for determining contaminants in salt melts was also published by W. Ding et al. (Electrochemical Measurement of Corrosive impurities in molten chlorides for thermal energy storage, Journal of Energy Storage. 2018; 15: 408-414), which is also included herein by reference in its entirety.

The process according to the invention may be employed, in particular, in the context of heat storage systems based on high temperature salt melts. For example, a high temperature salt melt can be purified by the process according to the invention before being used. In particular, however, the process according to the invention may also be used during the use of a high temperature salt melt as a heat storage system or transfer medium, in order to guarantee the operation permanently, and inhibit corrosion in the system. In particular, a salt melt in a storage tank can be purified with the process according to the invention, or continuously maintained in as pure as possible a condition. For example, the concentration of contaminants may also be monitored continuously, for example, by cyclic voltammetry, and a purification performed if necessary. For this purpose, for example, part of the salt melt may also be conveyed from the storage tank into a separate device for the purification of salt melts, and conveyed back into the storage tank after the purification.

In an alternative embodiment, the object of the invention is achieved by a device for purifying salt melts using the process according to the invention, comprising at least one device for cyclic voltammetric measurements, and at least one device for electrochemical purification, wherein said device for electrochemical purification includes an anode and a cathode, characterized in that said anode and cathode are made of the same material.

The device for electrochemical purification has at least two electrodes that are made of the same material. Thus, both electrodes are equally suitable as a cathode and anode. According to the invention, the material must have a suitable reduction potential, so that an oxygen- and/or hydrogen-based contaminant can be reduced at the cathode, and the anode oxidized at the same time by applying a suitable voltage.

The device for cyclic voltammetric measurements preferably includes a reference electrode, a working electrode, and a counter-electrode. In particular, the electrodes may be made of a material that is electrochemically inert under the conditions of the purification of salt melts according to the invention, such as tungsten, for example.

In a preferred embodiment, the device for purifying salt melts according to the invention includes two devices for cyclic voltammetric measurements. In particular, one device for cyclic voltammetric measurements is provided upstream from the device for electrochemical purification, and one device for cyclic voltammetric measurements is provided downstream from the device for electrochemical purification.

In particular, the device according to the invention may be connected to a storage tank for a high temperature salt melt. The salt melt may be conveyed from the storage tank into the device according to the invention, purified therein, and then conveyed back into the storage tank. Thus, the device according to the invention can be employed to keep a high temperature salt melt in a storage tank as free as possible from oxygen- and/or hydrogen-based contaminants during its time of use.

In a preferred embodiment, the device according to the invention may further include a heat exchanger. A heat exchanger is advantageous, in particular, if the purification of salt melts in the device according to the invention is to be performed at a temperature other than the storage temperature of the salt melt in the storage tank. When the salt is conveyed from the storage tank into the device according to the invention, heat can be added to or withdrawn from the salt melt. When it is conveyed back into the storage tank, heat can be withdrawn or added. In particular, said heat exchanger is a counter current heat exchanger. The heat exchanger improves the efficiency of the process in cases where the purification of the salt melt is to be performed at a temperature other than the storage temperature.

Preferably, the device according to the invention further includes a temperature control unit in order to control the temperature of the electrochemical purification and thus its efficiency.

In another preferred embodiment, the device according to the invention includes a cold trap having a wall temperature close to the liquidus temperature of the salt melt, in order to enable more processing by the precipitation of contaminants. This is the case, in particular, if the solubility of the contaminant is reduced at lower temperatures. Thus, contaminants dissolved at a high temperature can selectively precipitate in the cold trap.

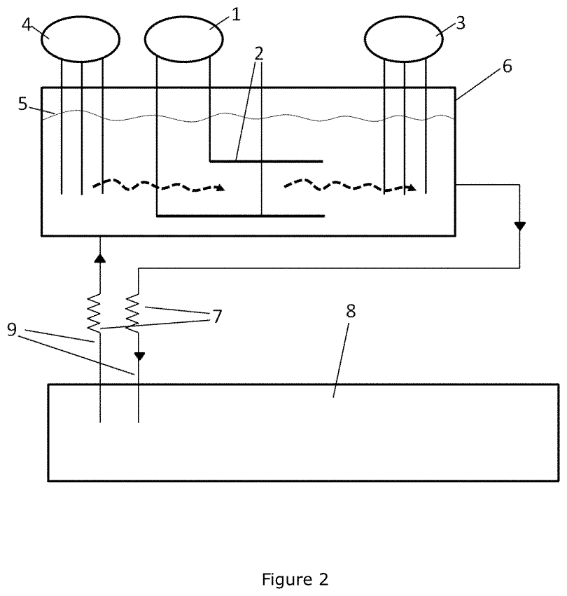

FIG. 2 shows a device according to the invention by way of example. The device includes a device for electrochemical purification 1 comprising two electrodes 2 that are made of the same material and can be employed both alternately as the anode or cathode. Further, the device according to the invention includes two devices for cyclic voltammetric measurements 3, 4, each of which includes a reference electrode, a working electrode, and a counter-electrode. The electrodes are immersed into a high temperature salt melt contained in a vessel 6. A gas phase 5 is provided above the high temperature salt melt. The vessel 6 is connected to a storage tank 8 through conduits 9. One conduit 9 goes from the storage tank 8 through a heat exchanger 7 and into the vessel 6. Another conduit 9 goes from the vessel 6 through the heat exchanger 7, and back into the storage tank 8. FIG. 2 shows the direction of flow of a high temperature salt melt by arrows. The device for electrochemical purification 1 is positioned, in the direction of flow, between the two devices for cyclic voltammetric measurements 4 and 3, so that the concentration of contaminants before the electrochemical purification can be determined by means of the device for cyclic voltammetric measurements 4, and the concentration of contaminants after the electrochemical purification can be determined by means of the device for cyclic voltammetric measurements 3.

### EXAMPLES

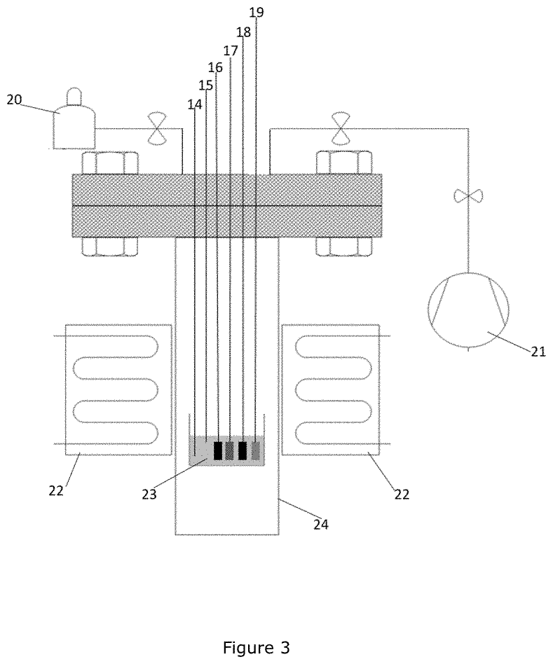

The following Examples relate to the purification of chloride salt melts and were carried out by means of an autoclave device as shown in FIG. 3. The device includes a tube furnace 22, control devices comprising, in particular, a temperature control unit, a metallic container 24, and a sample crucible 23, which is inert towards the salts employed. The sample compartment is connected to an argon container 20 and a vacuum pump 21, in order to be able to control the atmosphere in the sample compartment. Six electrodes are connected to the sample crucible: a tungsten electrode 14 as the reference electrode, a tungsten electrode 15 as the working electrode for cyclic voltammetric measurements, a tungsten electrode 16 as a counter-electrode for cyclic voltammetric measurements, an electrode 17 for determining the corrosiveness of the salt melt by means of potentiodynamic polarization measurements, and an electrode 18 and an electrode 19 as the cathode and anode for electrolytic purification. The autoclave is made of the alloy 1.4876 (Incoloy® 800H). The electrode 17 is also made of Incoloy® 800H in order to be able to determine the corrosiveness of the salt melt towards this alloy. Incoloy® 800H is an iron alloy containing 30.52% by weight nickel, 20.47% by weight chromium, 0.58% by weight manganese, 0.50% by weight silicon, and 0.07% by weight carbon.

A mixture comprising 20 mole % NaCl, 20 mole % KCl and 60 mole % MgCl₂ was employed as the salt melt. At room temperature, 140 g of the salt mixture was evacuated in the sample crucible 23 at room temperature, and then heated at 200° C. under an argon atmosphere. The temperature was maintained at 200° C. for one hour under an argon atmosphere, in order to dehydrate the salt and thus reduce side reactions to form hydroxides. Subsequently, the mixture was heated at 500° C., wherein the salt mixture underwent a transition to the liquid phase.

### 1. Comparative Example—Process According to the Prior Art

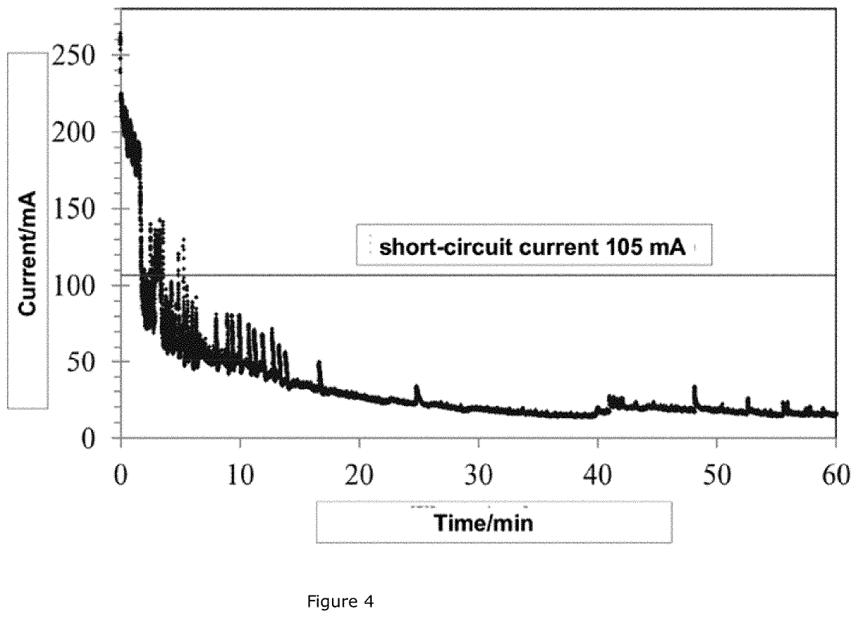

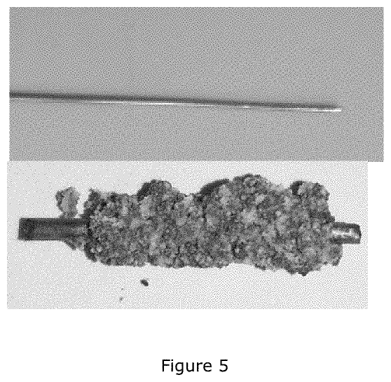

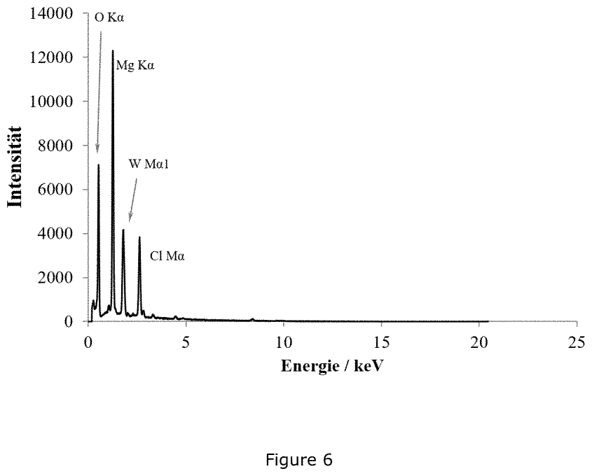

In a comparative experiment, a tungsten electrode was employed as the cathode 18, and a magnesium electrode as the anode 19, for the electrolysis in accordance with the process from the prior art. The electrolysis was performed for 60 minutes under a voltage of 0.5-0.7 V. In the course of the electrolysis, a fast decrease of the measured current was seen, which can be attributed to the formation of MgO on the tungsten cathode and thus to the passivation of the cathode. The decrease of current is shown in FIG. 4 as a function of time. Already within 4 minutes, the current decreases below the short-circuit current of 105 mA. The short-circuit current corresponds to the spontaneous flow of current when the unused magnesium anode is connected to the tungsten cathode without applying a voltage. The deposition of MgO at the cathode can be observed optically. In FIG. 5, the tungsten cathode is shown before the electrolysis (top), and after the electrolysis (bottom). By using energy-dispersive X-ray spectroscopy (EDS), it could be confirmed that the deposits at the tungsten cathode are MgO. In FIG. 6, corresponding EDS spectra are shown.

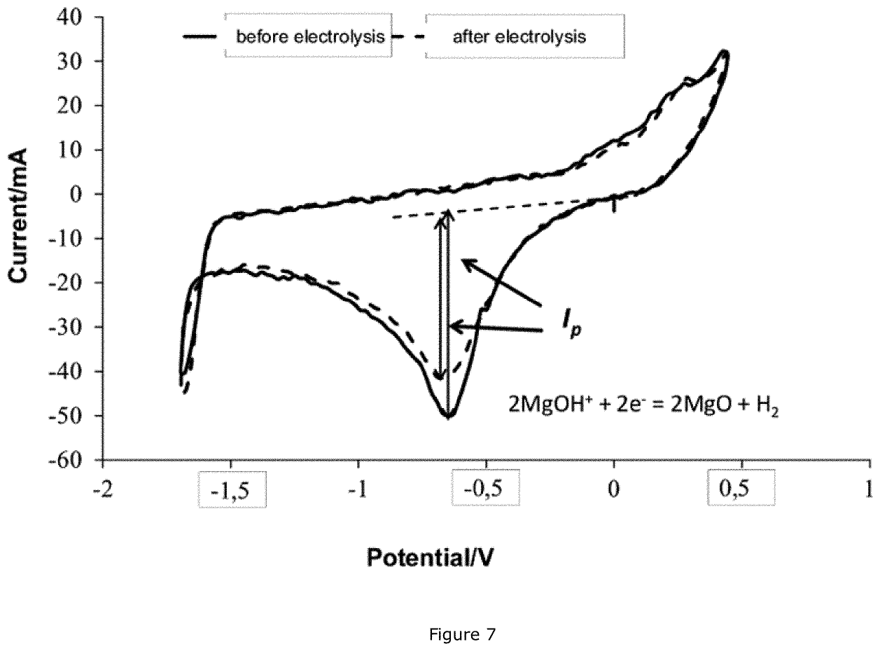

By using cyclic voltammetry, it was determined that only 15% of the MgOHCl contaminants could be removed after 60 minutes of electrolysis. FIG. 7 shows corresponding cyclic voltammetric measuring curves before the electrolysis and after the electrolysis. The measurements were performed with a potential feed rate of 200 mV/s. The contact area between the tungsten electrode 15 (working electrode) and the salt melt was 0.16 cm².

### 2. The Process According to the Invention

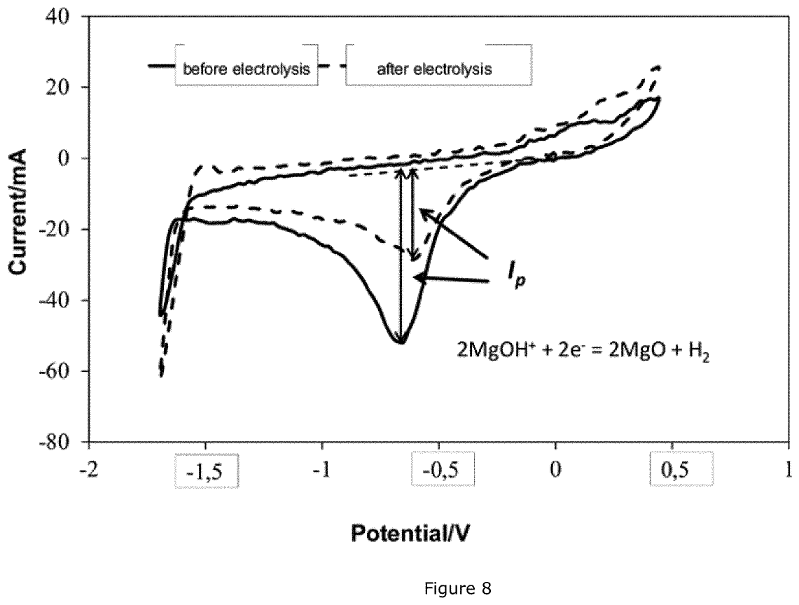

In an Example according to the invention, a magnesium electrode was employed for the electrolysis for both electrode 18 and electrode 19, wherein electrodes 18 and 19 were alternately employed as the anode and cathode. The salt melt was prepared as described above. After the salt melt had been heated to 500° C., the content of contaminants was determined by cyclic voltammetry. The measurement was performed in the same way as for the Comparative Experiment. The corresponding cyclic voltammogram is shown in FIG. 8. A clear signal is found at about −0.5 V, which is caused by the reduction of MgOH⁺ to MgO and H₂. Before the electrolysis, the peak current was about 50 mA, which corresponds to a peak current density of 313 mA/cm², when the contact area between the working electrode and salt melt is 0.16 cm². Since the peak current density is proportional to the MgOH⁺ concentration, it can be concluded that the concentration of MgOH⁺ in the melt was at 11938±2379 ppm O.

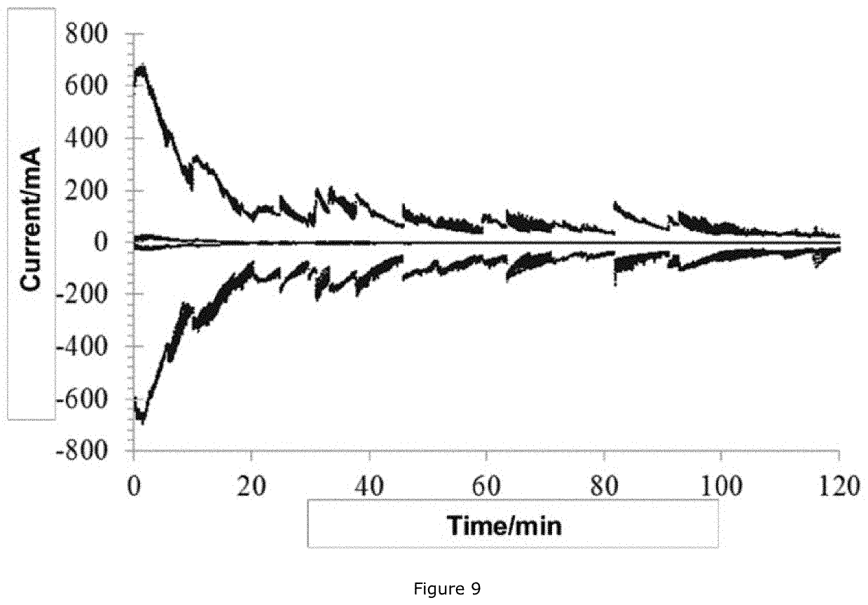

The electrolysis was performed for 120 minutes. A voltage with an absolute value of 0.8 V was applied between the two magnesium electrodes 18 and 19, wherein the direction or the sign of the voltage was swapped every 3 seconds. FIG. 9 shows the course of the measured current as a function of time. It is found that the current remains at a high value of more than 200 mA, especially within the first 15 minutes. The sharp drop of about 600 mA to about 200 mA within the first 15 minutes can be attributed to an initially strongly decreasing concentration of MgOH⁺. The leaps in the current can be attributed to the removal of deposits on the electrodes (falling off of MgO),

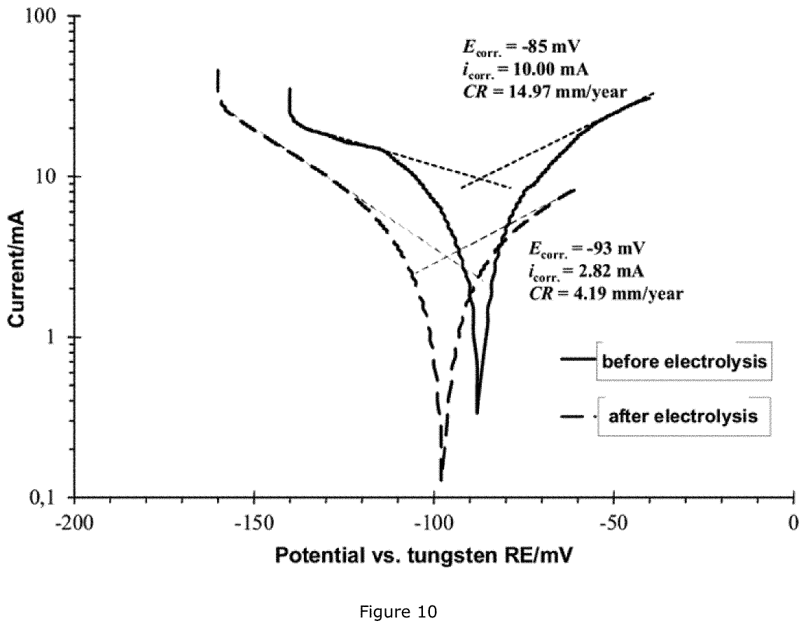

After the electrolysis, the content of MgOH⁺ was again determined by cyclic voltammetry, the cyclic voltammogram being shown in FIG. 8. The peak current for the reduction of MgOH⁺ dropped to 25 mA, the concentration of MgOH⁺ was thus reduced to 5969±1188 ppm O, which is half the original value. The corrosiveness of the original salt melt and of the salt melt purified according to the invention were determined by means of potentiodynamic polarization measurements. FIG. 10 shows polarization curves for Incoloy® 800H in the original salt melt and in the salt melt purified according to the invention at 500° C. Electrode 17, which had a contact area to the salt melt of 7.6 cm², was employed as the working electrode. The tungsten electrodes 14 and 16 were employed as the counter-electrode and reference electrode, respectively. The potential feed rate was 1 mV/s. Using the Tafel equation, the corrosion current was determined from the potentiodynamic polarization curve, which corrosion current was 10 mA for Incoloy® 800H for the original salt melt (corrosion current density: 1.32 mA/cm²), which corresponds to a corrosion rate of 15 mm/year according to Faraday's law. The corrosion current of the salt melt purified according to the invention was only 2.8 mA (corrosion current density: 0.42 mA/cm²), which corresponds to a corrosion rate of 4.2 mm/year. Thus, the corrosiveness of the salt melt could be lowered to 28% of the original value by the purification according to the invention.

1. A process for purifying salt melts, comprising the following steps:
i) providing a salt melt, wherein said salt melt contains at least one oxygen-based and/or at least one hydrogen-based contaminant;
ii) contacting the salt melt electrically and physically with at least one first electrode and at least one second electrode, wherein said electrodes are not in mutual contact within the salt melt;
iii) variably applying a voltage between said at least one first electrode and said at least one second electrode, so that an electric current flows between the electrodes, wherein said oxygen- and/or hydrogen-based contaminant is at least partially removed by an electrochemical reaction on at least one of the electrodes;
characterized in that the voltage is varied in such a way that said at least one first electrode acts as the cathode and said at least one second electrode acts as the anode during at least one first phase, and said at least one first electrode acts as the anode and said at least one second electrode acts as the cathode during at least one second phase.

2. The process according to claim 1, characterized in that the voltage is varied in such a way that said at least one first electrode and said at least one second electrode alternately act as the anode, the other electrode respectively acting as the cathode.

3. The process according to claim 2, characterized in that the voltage is varied with a period length within a range of from 0.1 to 10 seconds, especially within a range of from 1 to 4 seconds.

4. The process according to claim 1, characterized in that said salt melt includes a halogen salt, optionally a chloride salt.

5. The process according to claim 1, characterized in that said salt melt includes a cation selected from the group consisting of Mg, Ca, Na, K, Li, Sr, Ba, Zn, Al, Sn, Fe, Cr, Mn, and Ni.

6. The process according to claim 1, characterized in that said at least one first electrode and/or said at least one second electrode include a material having a reduction potential that is not higher than a reduction potential of an oxygen- and/or hydrogen-based contaminant.

7. The process according to claim 1, characterized in that said at least one first electrode and said at least one second electrode are made of the same material, or from different materials.

8. The process according to claim 1, characterized in that said at least one first electrode and/or said at least one second electrode include an alkali metal, optionally lithium, sodium, or potassium, an alkaline earth metal, optionally magnesium, calcium, strontium, or barium, a transition metal, especially cobalt, nickel, iron, or zinc, or a metalloid, optionally boron, or silicon.

9. The process according to claim 1, characterized in that said process is performed at a temperature within a range of from 300 to 800° C.

10. A device for purifying salt melts using a process according to claim 1, comprising at least one device for cyclic voltammetric measurements, and at least one device for electrochemical purification, wherein said device for electrochemical purification includes an anode and a cathode, characterized in that said anode and cathode are made of the same material.

11. The process according to claim 2, characterized in that said salt melt includes a halogen salt, optionally a chloride salt.

12. The process according to claim 3, characterized in that said salt melt includes a halogen salt, optionally a chloride salt.

13. The process according to claim 2, characterized in that said salt melt includes a cation selected from the group consisting of Mg, Ca, Na, K, Li, Sr, Ba, Zn, Al, Sn, Fe, Cr, Mn, and Ni.

14. The process according to claim 3, characterized in that said salt melt includes a cation selected from the group consisting of Mg, Ca, Na, K, Li, Sr, Ba, Zn, Al, Sn, Fe, Cr, Mn, and Ni.

15. The process according to claim 4, characterized in that said salt melt includes a cation selected from the group consisting of Mg, Ca, Na, K, Li, Sr, Ba, Zn, Al, Sn, Fe, Cr, Mn, and Ni.

16. The process according to claim 11, characterized in that said salt melt includes a cation selected from the group consisting of Mg, Ca, Na, K, Li, Sr, Ba, Zn, Al, Sn, Fe, Cr, Mn, and Ni.

17. The process according to claim 12, characterized in that said salt melt includes a cation selected from the group consisting of Mg, Ca, Na, K, Li, Sr, Ba, Zn, Al, Sn, Fe, Cr, Mn, and Ni.
